(19) United States
(12) Patent Application Publication
(10) Pub. No.: US 2014/0257901 A1
(43) Pub. Date: Sep. 11, 2014

(54) SYSTEM AND METHOD FOR INTEGRATED SERVICES, PROJECTS, ASSETS AND RESOURCE MANAGEMENT USING MODULAR ANALYTIC TOOL AND RELATIVE VARIANCE TECHNOLOGY

(71) Applicant: SUBRAMANYAM K MURTHY, CHINO HILLS, CA (US)

(72) Inventor: SUBRAMANYAM K MURTHY, CHINO HILLS, CA (US)

(21) Appl. No.: 14/201,890

(22) Filed: Mar. 9, 2014

Related U.S. Application Data
(60) Provisional application No. 61/775,616, filed on Mar. 10, 2013.
(60) Provisional application No. 61/775,618, filed on Mar. 10, 2013.
(60) Provisional application No. 61/775,619, filed on Mar. 10, 2013.

(51) Int. Cl. G06Q 10/06

(52) U.S. Cl. CPC G06Q 10/06313
USPC 705/7.17

(57) ABSTRACT

This invention is designed to implement a practical approach to project governance with the key objective of managing technical resources to deliver cost-effective services and maximize efficiency, time and cost for an organization. The integrated resource management software provides configurable services, workflows and dashboards to manage a specific project. The system and method overcomes the technological challenge by making it easy to use and providing a novel nodal architecture approach to create modular intelligent analytical tools. A novel formula is used to calculate the outcome for relative variance technology used for the services, projects, assets and resource management for a specific project. Modular intelligent agents are customizable for individual users to monitor, manage, triage, assess progress and take decisions at every step of the project.

### CROSS REFERENCE TO RELATED APPLICATION

This application is a utility application of the previously filed U.S. Provisional Applications 61/775,616, 61/775,618 and 61/775,619 filed on 10^{th} Mar. 2013. The pending U.S. Provisional Applications 61/775,616, 61/775,618 and 61/775,619 are hereby incorporated by reference in its entireties for all of its teachings.

### FIELD OF TECHNOLOGY

This disclosure relates generally to a system and a method for integrated services, projects, assets and resource management tied to budgets that includes engineering, engineering innovation initiatives, service and project management. More specifically a modular intelligent agent, an analytical tool having an embedded relative variance technology to manage projects, resource and assets at an enterprise level.

### BACKGROUND

Managing technology and engineering resources have always been a challenge to management. There are many issues related to resources that are shared across enterprise for different activities making management and resource allocations challenging and very difficult. This chasm continues to cause managements significant challenges in understanding how resources are being utilized, and allocating and optimizing budgets, resources and workload allocations to ensure that they are delivering what the business needs.

Over half of engineering initiatives and projects fail either due to cost overruns or delays or business contingencies. One of the reasons for their failure is the inadequate management monitors that fail to alert management on any impending adverse outcome. Traditional management monitors use Cost Variance and Schedule Variance. Cost Variance indicates how much over or under budget the project is, whereas Schedule Variance indicates how much ahead or behind schedule is. The issue is that these monitors alone are not sufficient to manage engineering initiatives and projects. They do not quantify the workload dynamics. Three other factors affect performance: Scope creep, critical issues that dynamically shift in time, and risk. If true progress and success cannot be measured, then they cannot be managed. Unmanaged workloads impact the business significantly as enterprises will only know the adverse impact after the fact. Many industries would like to assess the performance for an enterprise to reconfigure their success.

Many disparate analytical tools are available and one has to integrate them into their information technology systems. Non-availability of small customizable analytic tool is also an issue. Creation of industry specific analytic tool is very labor and capital intensive. There is a need for a versatile and integrated tool to help an enterprise function efficiently.

### SUMMARY

The invention relates generally to a system and a method for integrated services, projects, assets and resource management tied to budgets that include engineering, engineering innovation initiatives, service and project management.

The invention discloses a system and a method for using relative variance technology and algorithm for calculating, monitoring and predicting the progress of the project at an enterprise level.

In one embodiment, a computer, a machine readable media, a processor houses the integrated enterprise software that comprises of a modular intelligent agent as an analytical tool having an embedded relative variance technology to manage projects, resource, assets at an enterprise level.

In one embodiment, a system is created wherein the decision maker, user and service provider of the project can predict the different and disparate variables as a factor in the project management tool. In another embodiment, the algorithm allows a scope creep to be incorporated into cost calculation. In another embodiment, risks and critical issues that may arise during the course of the project life is allowed to be factored in as it happens.

In another embodiment, risk such as intrinsic risk and extrinsic risks are factored into the calculations. In one embodiment, a system for information technology is supported by the relative variance technology, method and algorithm. The installation, in one embodiment, may be done before and/or after the upgrade to the information technology system.

In one embodiment, several modules are present in a processor. The various modules are a service management module having a project scope module, cost module, personnel module, schedule module, assessment module and review module to perform effective service management; a project management module having a relative variance module, scope creep module, cost module, resource management module, critical issue assessment module, schedule module, budget module, and application/workflow module to deliver a project on time and budget; and a governance module having an efficiency centric module, business risk module, revenue management module, regulatory module, project monitoring module, review project module and approval module for all involved personnel to approve, review and complete the project.

In one embodiment, a relative variance module uses a Formula 2 and 3 (shown in detailed description below) for calculating the input of all the variables that feed into the service management module, project management module, governance module, resource module, reports module, administrative module, security module, network module and database module.

In one embodiment, a specific formula is used to calculate weighted project variance by using a processor for the entire organization or individual projects.

In one embodiment, the critical issues such as budget cuts, vendor changes, technology changes and personnel changes are factored in to perform relative variance calculations. In another embodiment, a visual display of the different factors and their impact on the project management will be done. In one embodiment, a system is created with a nodal architecture in mind. The nodal architecture allows the user to configure an analytical tool on demand. In another embodiment, a unique mechanism is provided to create hierarchy of analytics that is applicable to the business environment. The nodal structure for display is available for each user as customizable graphical user interface.

In another embodiment, there is no need for programming. A series of questions with prompts enables a novice user to create their own analytical tool for a given situation. In another embodiment, linear and nonlinear algorithms can be configured without a need for programming. In another embodiment, normalization algorithm and relative comparator algorithm can be reviewed side by side to enable the user to make decisions.

In one embodiment, the critical issues such as budget cuts, vendor changes, technology changes and personnel changes are factored in to perform effective analytical tool projections. In another embodiment, a visual display of the different factors and their impact on the project management will be done.

In one embodiment, a system and a method are created to manage enterprise wide service management. This allows the user not only to work efficiently but also ensures the integrity of the delivery system.

In another embodiment, a system is created wherein the manager of a project or engineering innovation initiative can predict the different and disparate variables as a factor in the management tool. In another embodiment, the algorithm allows a scope creep to be incorporated into cost calculation. In another embodiment, risks and critical issues that may arise during the course of the project life is allowed to be factored in as it happens.

In another embodiment, agents help drive down the effort required by humans by performing the work they would normally perform and thereby increasing productivity and accuracy. These agents are intelligent and understand the need for efficient workload allocation. These agents have the intelligence to learn processes and help configure the system automatically to meet business needs. As businesses evolve, agents help adopt the system to meet new challenges.

In another embodiment, risk such as intrinsic risk and extrinsic risks are factored into the calculations. In one embodiment, a system for information technology is supported by the relative variance method and algorithm. The installation, in one embodiment, may be done before and/or after the upgrade to the information technology system.

In one embodiment, a method of collecting a data from a service management module, resource management module, project management module and calculating a relative variance value for a granular attribute that integrates into a specific project; calculating and presenting the relative variance value as a weighted project variance across for the granular attribute that influences the specific project goals for an integrated enterprise system, to a decision maker, service provider and user; enabling assessment of the specific project at a specific point to a member of the specific project and make necessary allocation of a service, resource and project related allocation, designing the specific project by the decision maker, service provider and user by using the modular intelligent agent; and monitoring the specific project by the decision maker, service provider and user by using the modular intelligent agent is presented.

In another embodiment, monitoring the specific project by the decision maker, service provider and user by using the modular intelligent agent is critical for project success. In another embodiment, adjusting the allocation of the service, resource and the project related allocation in response to a critical issue assessment result as well as alerting a change in at least one of a critical issue, business risk issue, schedule, budget, scope creep and resource to the decision maker, service provider and user by using the modular intelligent agent is important across the enterprise. In one embodiment, permitting customization of a graphical user interface for the decision maker, service provider and user by using the modular intelligent agent to observe a workflow of the specific project enables the stake holders such as the decision maker, service provider and user to tap into every granular element of the specific project such as people, cost, resource, budget and impeding issues such lack of resource etc. In another embodiment, displaying a project flow chart for a decision maker, service provider and user with appropriate indication of a decision requirement to move forward for the specific project by the modular intelligent agent is useful to get a bird's eye view of the specific project steps.

Other features will be apparent from the accompanying figures and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 shows an entire system for processing varied data and enriching the varied data 1900, according to one or more embodiments.

FIG. 2 is a diagrammatic system view of a computer device view in which any of the embodiments disclosed herein may be performed, according to one embodiment.

FIG. 3 is a representation of different modules being used through a processor is shown.

FIG. 4 is a representation of service management module.

FIG. 5 is a representation of project management module.

FIG. 6 is a representation of governance management module.

FIG. 7 is a view of the integrated management user interface.

FIG. 8 is a view of the resource management user interface.

FIG. 9 shows a view of the resource allocation and utilization user display.

FIG. 10 shows a view of the budget management user display.

FIG. 11 is a view of the human resource management user interface.

FIG. 12 is a view of the configuring service management agents.

FIG. 13 shows how the entire system can be configured to adapt to Enterprise changes.

FIG. 14 shows how agents work behind the scenes to improve project approval process.

Other features of the present embodiments will be apparent from the accompanying the detailed description that follows.

### DETAILED DESCRIPTION

The invention defines a system and a method for integrated services, projects, assets and resource management tied to budgets that include engineering, engineering innovation initiatives, service and project management. More specifically a modular intelligent agent, an analytical tool having an embedded relative variance technology to manage projects, resource and assets at an enterprise level. In one embodiment, the system and method provides service management, project management, asset management, resource management, Information Technology (IT) analytics and dashboards that provide a 360 degree view of budgets, expenditures, resources, services delivered, projects implemented and value created. More particularly the disclosure details how to create a change in real time and manage the implication of change for a particular service or project or engineering initiative using a dashboard with a modular analytic tool using relative variance technology and agent technology to assess status of technology deliveries at an enterprise level as compared to traditional projections.

Enterprises incur significant expenditures on tools and staff. These costs are not just one-time costs but high recurring expenses. The one-time expenses include buying, customizing and deploying tools for managing customer support, services, projects and a separate tool for integrating data & building Analytics. The recurring expenses include multiple tool maintenance of multiple tools, and Project Management Office (PMO) to manage projects, support staff to analyze performance and generate reports. Our solution is an integrated resource. Change in one area will automatically be reflected on the other. For example if a person is being moved from one project to other not only would we show change in personnel but we would automatically update the budget. The project dashboard will also show the task that would be affected by the personnel change and if not the benefit of resource allocation. A complete view of change in real time makes the managers more effective and role changes less complicated to run several projects smoothly. There is also the need for automated ways to manage the performance. Having human intervention and inputs at every stage creates onerous workload and barriers to developing systems for improving workload performance.

This disclosure shows an integrated workload management system and method that includes service management, project management system and implementing engineering initiatives. More particularly the disclosure details how to create a change in real time and manage the implication of change for a particular project using a dashboard. The software applications themselves may operate on a variety of devices, including servers, processors and mobile devices. There is a need for calculating the variables that impact the business and will make the workload allocation more effective. This has created the need for a customizable collection of small analytic tools that may be available for decision makers to create and use in real time to assess the engineering, service and project management system with dashboards that may be available for decision makers to create and use in real time to assess their overall performance. There is also a need for calculating the variables that impact the engineering, service and project management system and will make the workload allocation more effective.

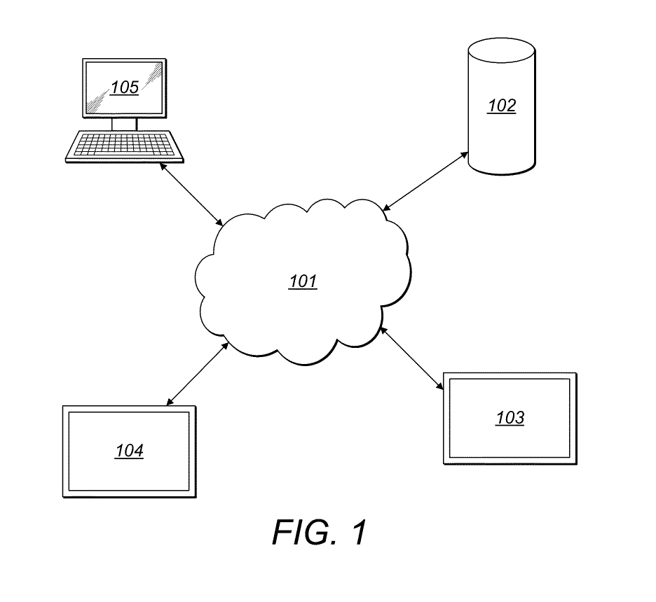

FIG. 1 shows a system view of the integrated technology management system being used by different types of hardware. The software called integrated technology management software may be installed either locally or in cloud for a single user or multiple users. The hardware may be a laptop 105, a computer 104 and/or 103 or any other mobile devices. They may be connected through a network 101 and the data may be stored in a database 102. The software may be installed on a central server or on a local device processor. The software may be created as an application to be downloaded using the network 101, and also the network may be used for cloud based application, cloud sourced application or subscription based applications and cloud based services may support this configuration. The network 101 may be a local area network (LAN), Wide area network (WAN), mobile, telecommunications, internet, intranet, cloud computing, mobile, WiFi and/or ZigBee network, etc.

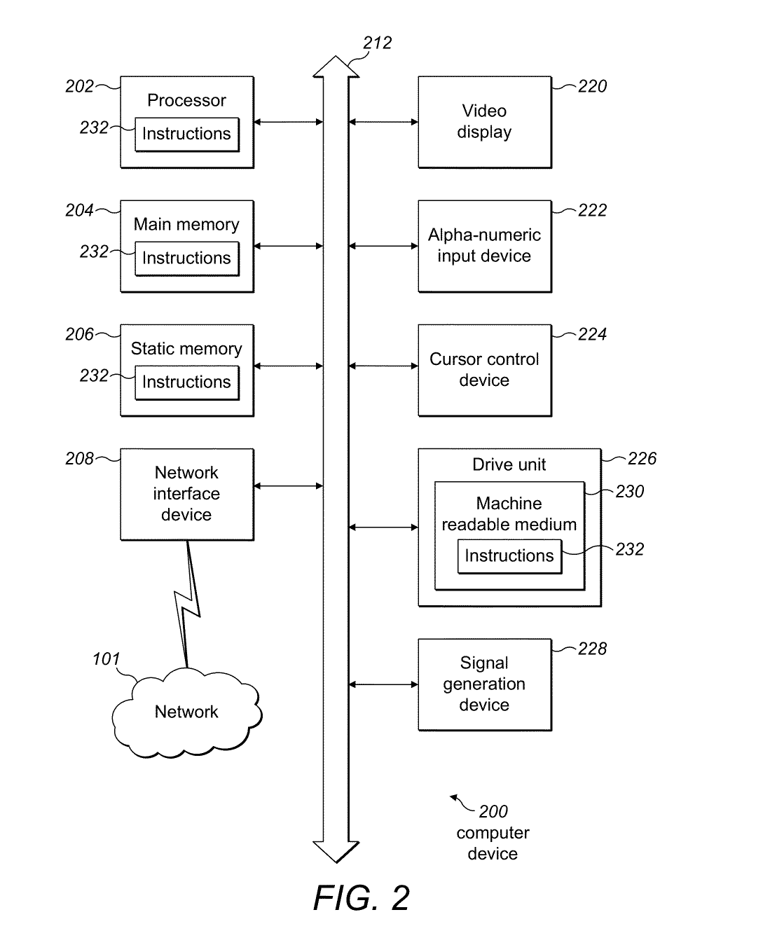

FIG. 2 is a diagrammatic system view 200 of a computer device view in which any of the embodiments disclosed herein may be performed, according to one embodiment. Particularly, the computer system view 200 illustrates a processor 202, a main memory 204, a static memory 206, a bus 212, a video display 220, an alpha-numeric input device 222, a cursor control device 224, a drive unit 226, a signal generation device 228, a network interface device 208, a machine readable medium 230, instructions 232, and a network 101, according to one embodiment.

The computer system view 200 may indicate a personal computer and/or a data processing system (e.g., server) in which one or more operations disclosed herein are performed. The processor 202 may be microprocessor, a state machine, an application specific integrated circuit, a field programmable gate array, etc. The main memory 204 may be a dynamic random access memory and/or a primary memory of a computer system. The static memory 206 may be a hard drive, a flash drive, and/or other memory information associated with the computer system. The bus 212 may be an interconnection between various circuits and/or structures of the computer system. The video display 220 may provide graphical representation of information on the data processing system. The alpha-numeric input device 222 may be a keypad, keyboard and/or any other input device of text (e.g., a special device to aid the physically handicapped). The cursor control device 224 may be a pointing device such as a mouse.

The drive unit 226 may be a hard drive, a storage system, and/or other longer term storage subsystem. The signal generation device 228 may be a bios and/or a functional operating system of the data processing system. The network interface device 208 may be a device that may perform interface functions such as code conversion, protocol conversion and/or buffering required for communication to and from a network (e.g., the network 101 of FIG. 1). The machine readable medium 230 may provide instructions on which any of the methods disclosed herein may be performed. The instructions 232 may provide source code and/or data code to the processor 202 to enable any one/or more operations disclosed herein. In an embodiment, a computer program product is provided. The computer program is stored on a computer-readable medium comprising software code adapted to perform the steps of the method 100 (FIG. 1) according some embodiments when executed on a data-processing apparatus.

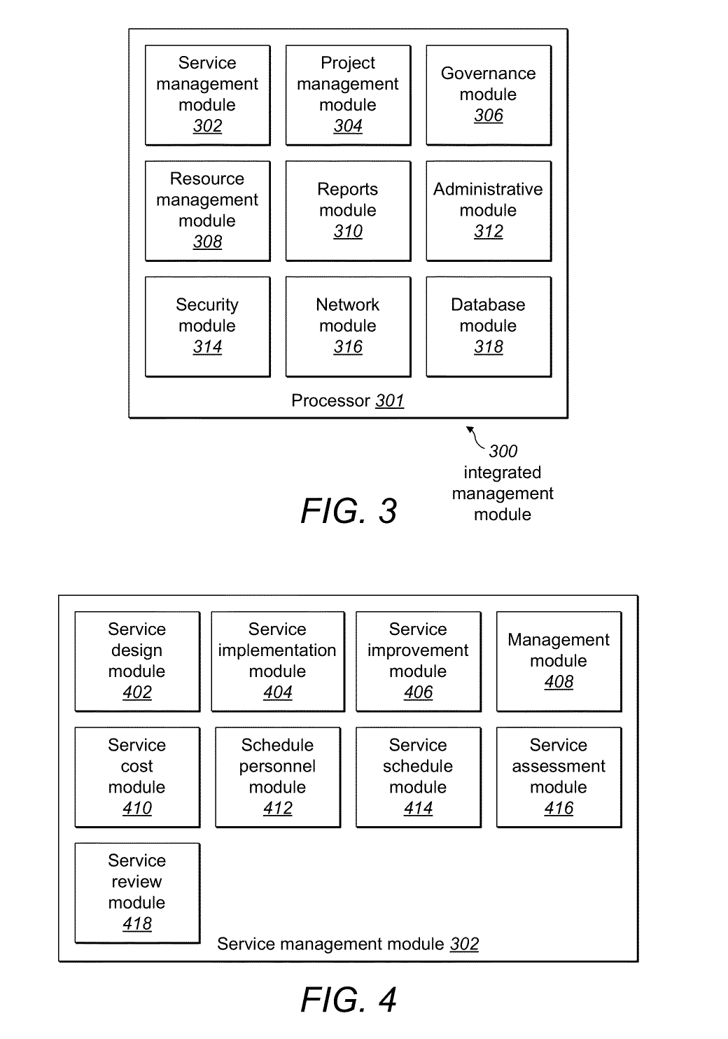

As shown in FIG. 3 the integrated management module 300 system and method of using the same may be implemented in any suitable form including hardware, software, firmware or any combination of these. However, preferably, the invention is implemented as computer software running on one or more data processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

FIG. 3 shows a processor that may contain several modules, but not just limited to these, in a particular instance. Project management module 304 and network module 316 are found in traditional project management software. In the instant integration of all the modules of project management 304, network module 316, resource management module 308, service management module 302, reports module 310, administrative module 312, database module 318 and security module 314, net are a value added proposition. Existing indicators such as project and network management modules (304 and 316) alone is not adequate to monitor project progress. Instant invention incorporates several factors based on integrated approach to enhance the productivity and increase the profits for the industry.

Security module 314 is of paramount importance to keep the financial data, activity data and audit trail to be kept very securely. In one aspect if the entire enterprise system and method is conducted on internal network, cloud computing (private, public or hybrid), cloud sourcing and a combination of internal and external network architecture, levels of security, external data compromise situations and internal data safety issues need to be implemented through the security module 314 to deliver a save and stable system for use by the user, decision maker and service provider. Levels of data protection, data masking, data recovery and data encryption, user authentication methods, not limited to, are some of the security functions that may be implemented in the security module 314.

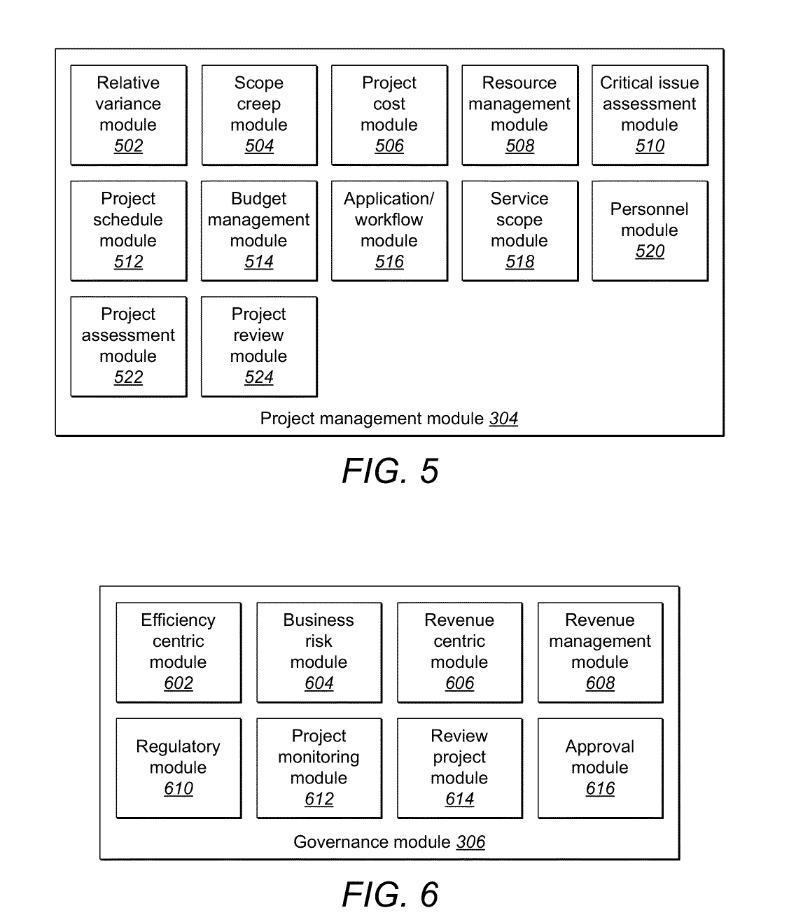

Service management module 302 is discussed in description of FIG. 4. Project management module 304 is discussed in detail in FIG. 5. Governance module 306 is discussed in FIG. 6. Reports module 310 spans across all modules present in integrated management module 300 to gather data, display, modify, calculate, assess, and provide suggestions for improvements. Reports module 310 also displays data changed using intelligent agents that use different formula to calculate variables and weighted project variance novel to this disclosure. Later figures will describe the graphical interface display of these results for different users, such as decision maker, service provider and an individual user. The decision maker may be, but not limited to, management personnel on the service provider or the client side. Individual user or users may be any person who is either providing the service or receiving the service. Service providers may be described as individuals, team of individuals allocated for a specific project or span across multiple projects for an enterprise. Resource management module 308 (eRM™ (Enterprise Resource Management)) integrates resource management with enterprise needs and helps manage resources and assets to established budgets. It includes analytics and dashboards to help assess how well systems are performing, develop and manage budgets, assess Return on Investment (ROI) and manage resources.

Generally speaking, a computer server system is disclosed herein which may include a plurality of singular database module or multiple database modules (318) for storing user data for a user and/or a plurality of users, and at least one processing module comprising a plurality of processing threads for processing jobs for users based upon respective user data, The integrated management system 300 may further include a database group module or cloud storage option may connect between the plurality of database modules and the at least one processing module. More particularly, the database group module may be for selectively connecting the processing threads to corresponding database modules including respective user data for jobs to be processed, and determining when a database module becomes unresponsive and terminating processing thread connections to the unresponsive database module based thereon. The database module may also be for determining when the unresponsive database module becomes responsive and restoring processing thread connectivity thereto based thereon.

Administrative module 312 enables the administrator to set up use rules, use agents, user access and hierarchical access point for data, results, change agent use and various project related resource modules to be active. The enterprise wide project and contract based projects requires the administrator to set up the access to integrated management module, system and method to be controlled and tailored for the specific project and user.

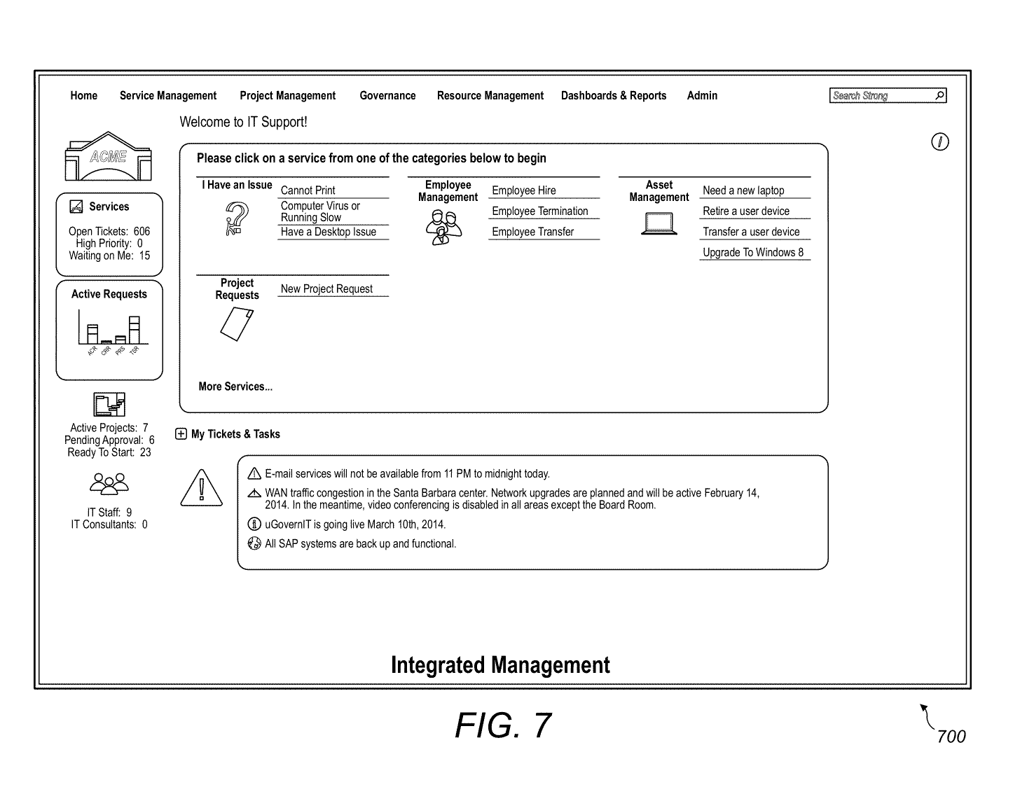

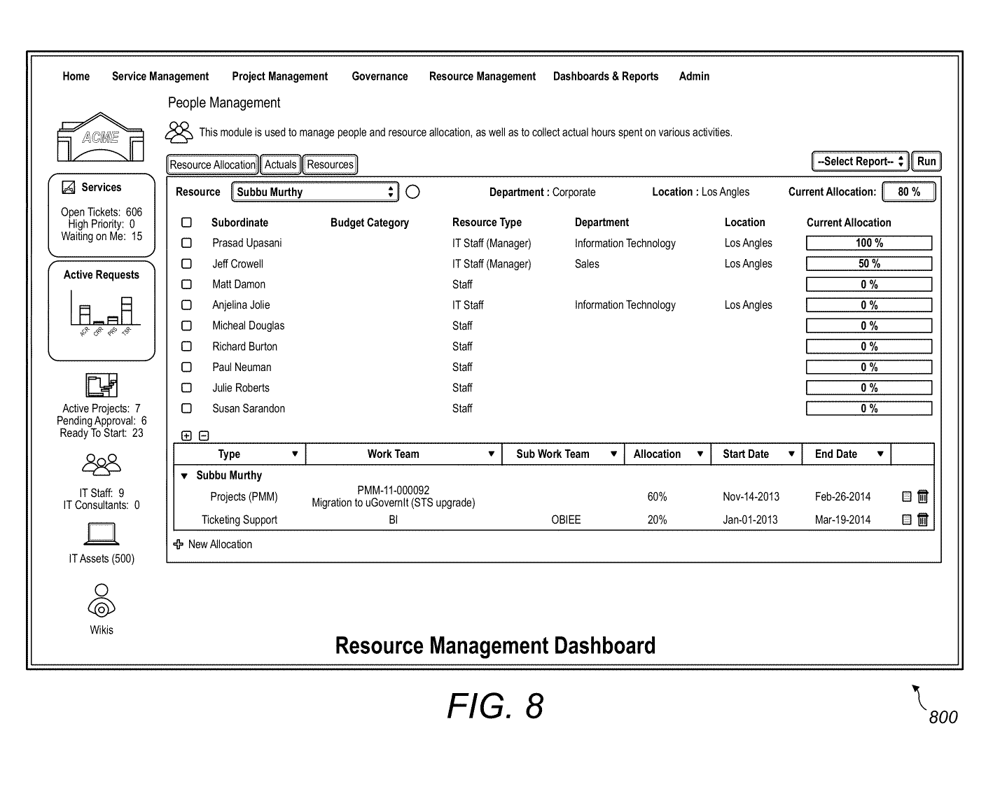

By using the instant integrated workload management software the users can design, develop and deliver technology services. At the same time they can design, develop and deliver technology initiatives. This common approach allows management to align resource priorities to business needs, and plan the budget with focus on effective re7source utilization as illustrated in FIG. 7 and FIG. 8. The advantages of using the instant invention are: It provides simple wizards and templates to configure the services that are best suited for the Enterprise as shown in FIG. 7.

Service management module 302 is elaborated in FIG. 4. It comprises of service design module 402, service implementation module 404, service improvement module 406, management module 408, service cost module 410, service personnel module 412, service schedule module 414, service assessment module 416 and service review module 418, but not just limited to these modules. This service management module 302 is a configurable module that serves the entire enterprise and IT department. Any enterprise or IT department requires service improvements, service strategy, service design, service transition and service operation on a daily basis. If the process of managing services to the enterprise is automated and linked to relative variance technology in one dash board it makes the enterprise and/or IT department more efficient and collaborative with the bigger goal of the industry. Service design module 402 may help identify the services, review existing services and identify services needed. The services may be open tickets for IT related issues, email services and disruption in email services, WAN traffic congestion problems, networking issues, financial system back ups, license renewals on software or hardware, security issues such virus attack, desktop issues, asset management such as computer procurements and video conferencing issues etc., but just not limited to these. Service implementation module 404 enables the user to prioritize by allocating a numerical value for a particular service management issue or service design module 402 issues and prioritizes the task list. Service improvement module 406 is a knowledge management tool that stores historical data for the service management module 302 and enables the user to analyze the success and failure for any particular service. Management module 408 allows the user, service provider and decision maker to create modular intelligent agents for efficient management. Service cost module 410 is one of the input channels for relative variance technology module and overall project cost prediction element.

Service personnel module 412 is a tool to allocate personnel to perform the tasks that has been listed by other modules in this integrated service management module 302. This also has budget implications and enables the user to evaluate the efficacy and efficiency of cost, implementation and design modules. Service schedule module 414 allows the user to prioritize and monitor the progress and slips of the particular service related projects. Service assessment module 416 is a powerful tool for each user to observe, make changes and monitor the service management tasks for on time and under budget delivery. Service review module 418 is used for ranking a service providers performance, an internal departments performance based on relative variance technology calculations and service cost module 410, and other modules present in the service management module 302 umbrella. This module 302 has implications on the overall integrated management for the industry.

FIG. 5 shows various modules that are incorporated in project management module 304. Project Cost module 506 and Project schedule module 512 are found in traditional project management software. In the instant invention scope creep module 504 in project management refers and reflects the consequence of uncontrolled changes or continuous growth in a project's scope. This phenomenon can occur when the scope of a project is not properly defined, documented, or controlled. Scope Creep module 504, project cost module 506 and project schedule module 512 along with other outputs are factored into calculating relative variance by the relative variance module 502 as novel feature in the instant application. Project Cost module 506 brings in input from resource costs, personnel costs, business expenditures, and various factors that influence project management.

Risk is generally considered a negative occurrence, and therefore should be avoided. Risks are both intrinsic (internal operations, sales, marketing, finance, HR) and extrinsic (how they impact your customers and supply chain). For enterprises also desiring to upgrade their IT system, they must assess the existing software and really scrutinize whether the upgrade is going to bring the benefits that are desired. Before embarking on the IT system upgrade, it is imperative to assess the risks.

Critical issue assessment module 510 factors a numerical value for the critical issues and risks that manifest in a specific project that refers to challenges that come up as a result of specific project execution. These factors include budget cuts, vendor changes, technology changes and personnel shifts which impact the projects. Critical issues are a result of the organizational dynamics prevalent in most projects. The term function mass and function weight will be used to help understand the role of organizational dynamics in the actual performance of a project. Mass is constant, whereas weight is dependent on the gravity. Using this metaphor, the cost of an IT project (mass) is weighted by the organizational dynamics.

The instant invention provides relative variance to capture project dynamics. Traditional variance uses the general formula: Variance=(Budget−Actual), and expressed as a percentage

Variance %=(Budget−Actual)/Budget (Formula 1)

Relative variance, in relative variance module 502, accounts for organizational dynamics by weighting the Variance across the organization. Let AV be the average variance, AB be the average budget for all projects considered. Using relative variance, the weighted project variance is equal to:

((Budget−Actual)/Budget))*((AV*Budget)/AB) (Formula 2)

It simplifies to the following:

Weighted Project Variance=((Budget−Actual)*(AV/AB)) (Formula 3)

The resource management module 508, schedule module 512 and budget management module 514 produces the data and feeds into the project management module 304. Application/workflow module 516 also has a point system that adds as data input for relative variance module and the database module 318 stores the data produced by various modules for current and/or further use. Every module represented in service management module 302, project management module 304 and governance module 306 factors in change in time, labor for resources and personnel and provides input for the weighted project variance formula 2 and 3. Application/workflow module 516 helps manage issues, tasks, projects and resources efficiently. It can be adapted to meet enterprises current needs and can readily be extended for growth. Application/workflow modules 516 also incorporate dashboards and help measuring progress, performance and manage resources effectively. The advantage of this technology is that the integrated approach facilitates that budgets are allocated appropriately and spent on the right projects, and just as importantly, at the right time.

By using the resource management module 508, which enables the user to input what personnel and material available as a resource and how much more or less one needs over a period of time is calculated, that feeds into relative variance module 502 to be used in formula 2 and 3.

In FIG. 6 governance module 306 and efficiency centric module 602 is novel wherein the user, decision maker and service provider can actually assign numbers to factors such as use of a certain machine is better than using another to improve productivity, or a contractor vs. a permanent employee to keep the specific project on schedule and under budget. This would influence the data for business risk module 604 and revenue management module 608. Business risk module 604 may help in bidding process by harvesting input factors from past and present projects. This may also provide a display as radio buttons based on critical issue assessment module 510 output whether to proceed with the project or not. Regulatory module 610 is essential for providing check boxes for international compliance for rules and regulations for a specific country and it allows the offsite project managers and decision makers to be cognizant of the fact that various country or location rules may influence their formula 1 and formula 2. Revenue centric module 606 allows the user to input data that have tangible input and directly relate to increasing revenue and not lose money on a specific project. It may feed into other modules such as cost module 404, approval module 616, and cost module 506. The difference between cost module 404 and cost module 506 is very subtle. Cost module 404 is looking at the cost from service provider point of view ad cost module 506 reflects the service receivers and decision makers budget. Cost module 404 reflects on profit and cost module 506 reflects on cost saving.

In one embodiment, Weight based methods typically score the IT with a formula such as: IT Benchmark score=(W₁*U) plus (W₂*S) plus (W₃*F) plus (W₄*E), where U is the macro analytic for user centered metrics, S for resource (IT staff or consultants) centered metrics, F is financial metrics and E are the external factors. Weights will vary based on the importance the Enterprise places on the specific analytic. For example, cost conscious Enterprises may give more weightage to W₃ whereas service centered Enterprises may give importance to W₂. The instant application has the capability to quickly customize using the modular intelligent agents for the specific set of analytics or granular attributes that work best for each IT organization in the context of the Enterprise.

Project monitoring module 612 enables a project request, triaging and management system to help prioritize the project request and facilitate tracking the projects costs, schedule, risk and assessing the project performance. The technological advancement of this invention is the algorithm specifically developed to tackle issues arising out of the project management and adding the disparate human points as a quantified number to generate timely and meaningful solutions for the project to be successful.

This disclosure shows a variety of systems and methods for creating and using modular analytic tool to assess status of the project at an enterprise level. More particularly the disclosure details how to create a tool in real time and assess the implication on a particular project. Analytics go beyond a Balanced Score Card and provides insights to improve the effectiveness of technology and services delivered by the IT group. The system and method has overcome the technological challenge by making it easy to use and can run in an interactive or batch approach. The analytical tool can be configured rapidly and deployed in hours. The software applications themselves may operate on a variety of devices, including servers, processors and mobile devices. Modular intelligent agents allow the user to create the basic ticketing system, user facing wizards to help users quickly and easily make user requests, mobile module to help manage user requests quickly, asset and change management modules to ensure the integrity of delivered services.

The IT Analytics solution built into the instant invention uses a unique Nodal architecture that allows users to define measures, aggregate them as metrics combined with Key Performance Indicators. These Key Performance Indicators can be combined into a composite analytic tool. The Nodal architecture allows us to configure analytics on demand without the need for programming. Using a unique wizard type interface, users can build different analytics and maintain them without the need for expensive software changes. The Nodal architecture also allows for a unique mechanism to create hierarchy of analytics that can adapt to the business environment. Using both linear and non-linear algorithms that can be configured without the need for programming, any model can be quickly constructed. The Normalization algorithm and the relative comparator algorithm ensure that different analytics can be reviewed side by side to help make decisions.

Approval module 616 provides a questionnaire that has been built-in to enable the user to create an analytical tool. The instant invention allows users to configure analytics that mirror the culture of the organization. For example, where IT is strategic and the IT changes are rapid, the analytics will focus on how agile the IT organization is to change/implement new systems at a high velocity. For stable organizations where user satisfaction and availability of services are critical, analytics will focus on user including response times, quality of resolution, speed of resolution, etc. Once the issue is identified, the implementation of analytics is relatively straightforward. Developing analytics involves seven steps: Identify dimensions/attributes, list all current metrics, narrow down the current metrics to a few based on criticality, assign weights to the selected metrics, collect baseline data, establish thresholds and compute analytics. The wizard interface allows users to run analytics without the need for knowing any technical jargon. The decision maker may use the approval module 616 to approve or disapprove the project or progress of the specific project.

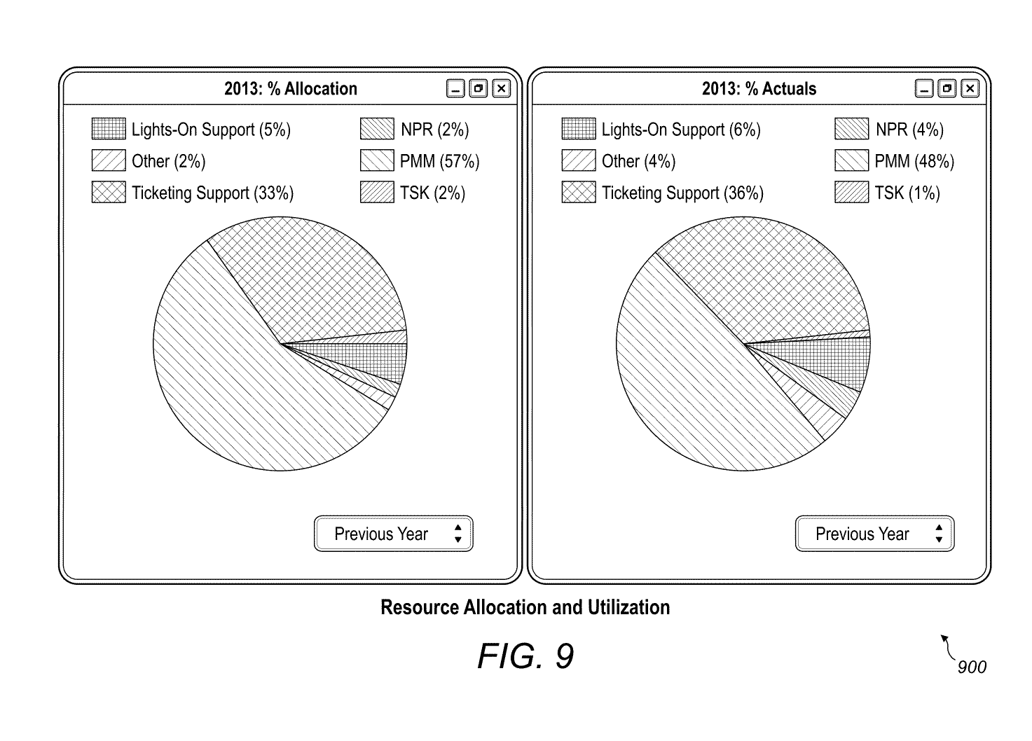

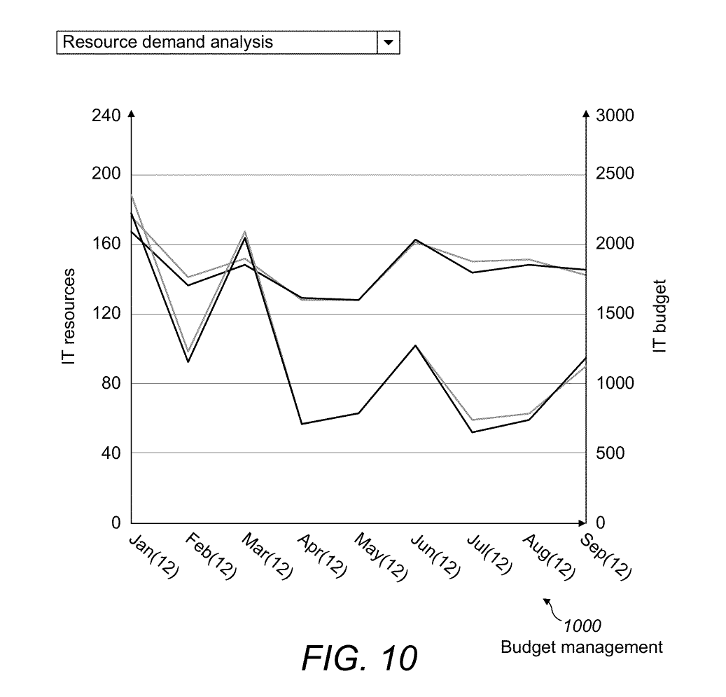

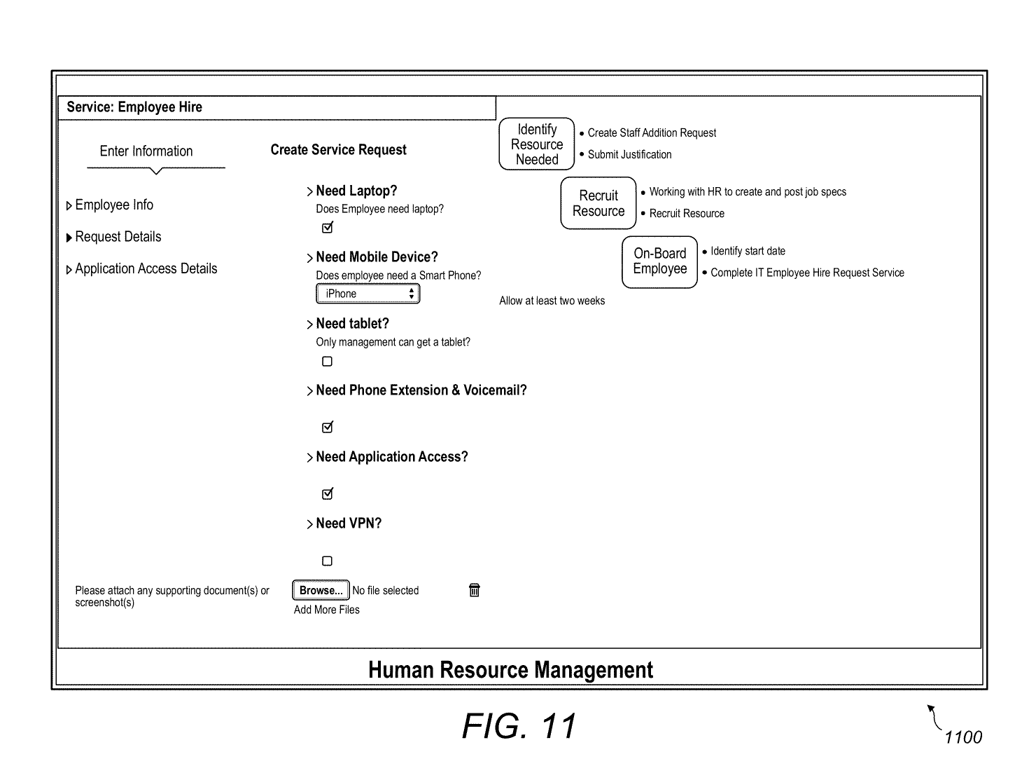

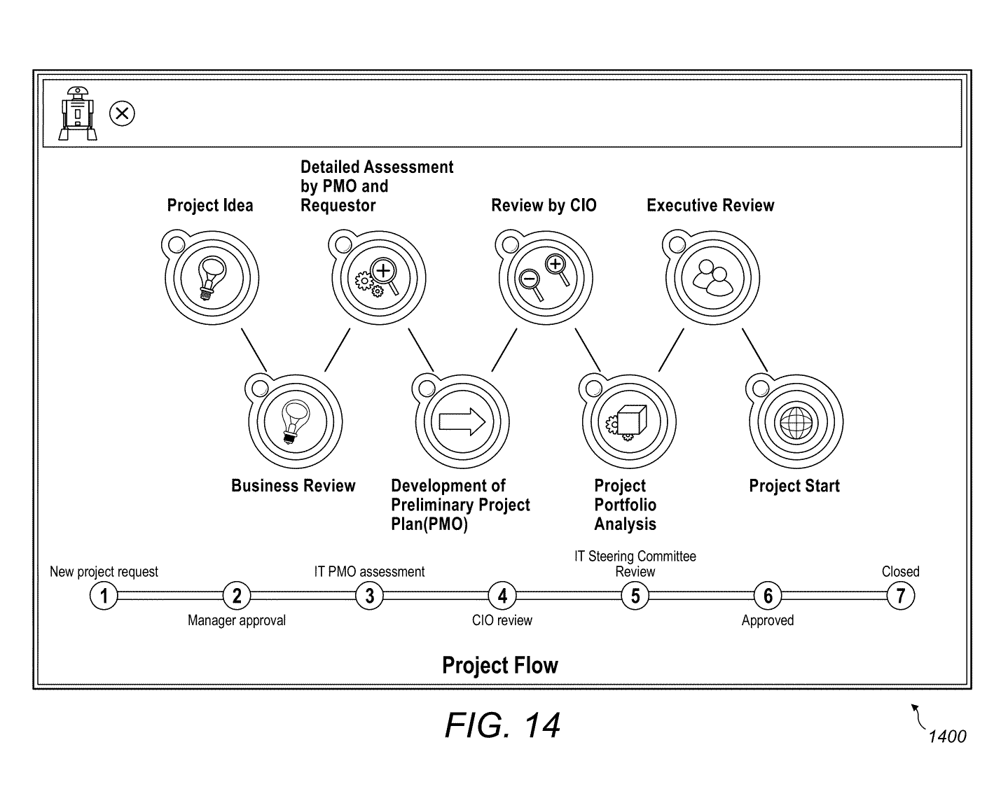

In one example, a business has a contract for a specific project pertaining to information technology. The client has specified the scope of the project which has been entered in project scope module or also known as service scope module 518. Project cost module 506 is used to estimate the cost, based on what was entered in personnel module 520 regarding how many people are needed, what is their hourly rate and commitment in schedule module 408 using intelligent agents that enable these modules in service management module 302. Project review module 524 allows the user, decision maker and service provider to see through the graphical user interface (GUI) resource management 800 in FIG. 8. Human resource management agents 1200 allow each user to configure various agents that are necessary to perform the services. Human resource management 1100 (FIG. 11), the GUI allows the user, decision maker and service provider to use the interface to utilize and feed data into service management module 302 and project management module 304 components to calculate the relative variance based on weighted average of formula 2 and formula 3. In the event of a scope creep, cost changes due to change in input by the service provider, critical issue assessment status arising due to resource constraints, or policy changes, the intelligent modular agent alerts the decision maker, service provider and the user. The resource allocation and utilization 900 (FIG. 9) and/or budget management GUI 1000 (FIG. 10) and the project flow dashboard 1400 (FIG. 14) would alert the right team or user or decision maker of the change and implication. This novel integrated display of different elements across the enterprise helps save money, resource and time overruns for an organization. The ability to witness this cause and effect that may enhance and guide future projects to a success is a very powerful tool for an organization.

Staff centered IT analytics include staff morale, resource utilization, transparency, productivity and turnover. Financial IT analytics includes number of capital projects, return on investments (ROI), variance and percentage of IT expenditures on new projects. External IT analytics includes outside threats, Disaster Recovery (DR) incidents, and technology adoption velocity and percentage budget allocated to contingency. IT Analytics can be used to benchmark the overall IT architecture and how it aligns to the business. This analytic is very comprehensive and requires management commitment to develop it. It combines Key Performance Indicators (KPIs) from the four areas; Financial, Customer, Internal Business Process, and Learning and Growth. For example a Financial KPI is cost to budget ratio, a User KPI is percent of Service Level Agreement (SLA) achieved, an Internal Business Process KPI is percentage of resources dedicated to maintenance, and a sample Learning and Growth KPI is percentage of IT staff with at least a college degree. The Balanced Scorecard Analytic provides an integrated measurement of the value of IT as a whole. Information Technology Infrastructure Library (ITIL) provides over 100 KPIs. A subset of these KPIs may be easily combined into an integrated analytic using a cumulative score that can be established at different stages of IT evolution within an enterprise and trended to identify benefits of proposed IT investments. Combining the four macro analytics can vary from simple weight based methods to more complex algorithmic based models.

FIG. 7 shows a graphical user interface of integrated management 700. This is a GUI welcoming a user to start their customizable GUI using various intelligent agents to configure their project specific dash board. This is a specific example for IT support dash board. It allows the user to track the pending tickets for issues that is present either in normal official business or specific project based business. The left hand panel shows Active requests if a manager or the responsible person to fix the issues and want to have a bird's eye view throughout the organization. It also enables the user, decision maker, service provider to hire and fire people based on the budget.

FIG. 8 shows the resource management dashboard 800. This is a novel approach for the user to be connected using this dash board to the underlying modules that are related to making changes in real time using the intelligent agents such as resource management, actual and resources that are available for a specific project. For example “Subbu Murthy” is managing the project. He has a pool of talent under the title of “subordinates”. He also is aware of the actual budget allocation. Once he allocates the personnel to finish the job he has a view of the proposed budget. Modular intelligent agent would feed into the formula 2 and 3 to calculate the weighted relative variance using and getting feed from various modules in integrated management module 300. It gives him the view of what resources are overused or underused, if the change of resources would allow him to be on budget or even under budget so that he may have contingency fund to complete the specific project successfully. This is the novel feature and just not yet another project management tool that is disparate and does not allow real time calculation of resource, budget and personnel in one access point. This also leads to decision maker and service provider dash board so that they are also aware of it in real time.

FIG. 9 shows a graphical user interface with graphical display of resource allocation and utilization 900. This may allow the user to have a compact view of the changes, presentation mode and quick decision on moving forward. One may also click on individual elements and expand to see what the underlying data is. Make changes and see the change effect and compare it to year by year comparison. This enables decision makers to compare vendors and teams across the enterprise or organization and see if any adjustments need to be made.

FIG. 10 is a view of budget management 1000. This is a graphical user interface for assessing resource demand analysis for an IT resource vs. IT budget on a monthly basis. This enables the user, decision maker and service provider to review the hourly demand and/or number of personnel so they can allocate the work without burdening one person or team of people.

FIG. 11 shows a dash board for human resource management 1100. This embodiment shows that this integrated tool is just not restricted to information management team or a specific project based tool. It also allows other departments such as finance; human resources, executives, IT, or any other business pertinent departments to create a modular agent based customizable dash board. Every integrated management module elements drive the modular intelligent agent and in real time the related department, user dashboards are updated. There is after the fact analysis and a reason to fail. In this FIG. 11 a human resources personnel is allocating office resources for an existing employee or a new employee that would feed into human resources budget and determine what is being spent. Identify resource needed, recruit resource and on board employee boxes show how integrated the human resources management dash board is.

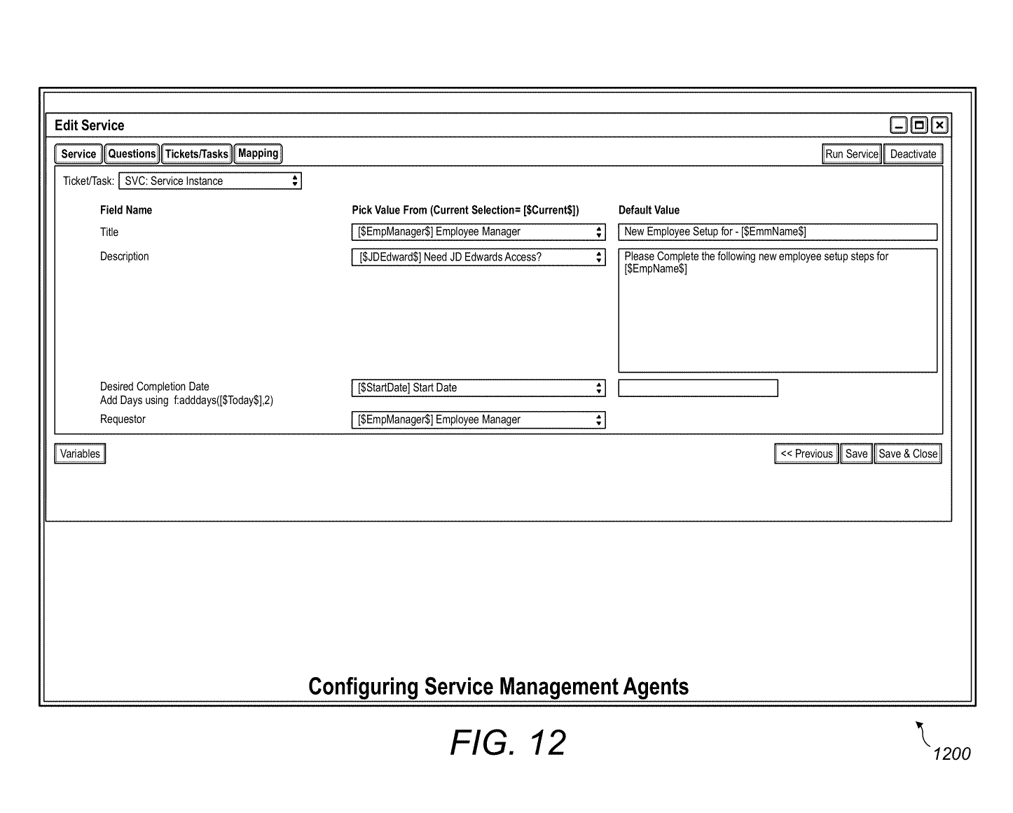

FIG. 12 shows an interactive configuring service management agent 1200. This may be used by individual users, experienced users, decision makers and service providers. Once the scope of a specific project is known the need for editing the service values may arise. This particular dashboard enables the individual to program the modular intelligent agent to be configured based on the changes. One may factor 1 the variables so that the projection, actual and the bid reflect the changes in real time.

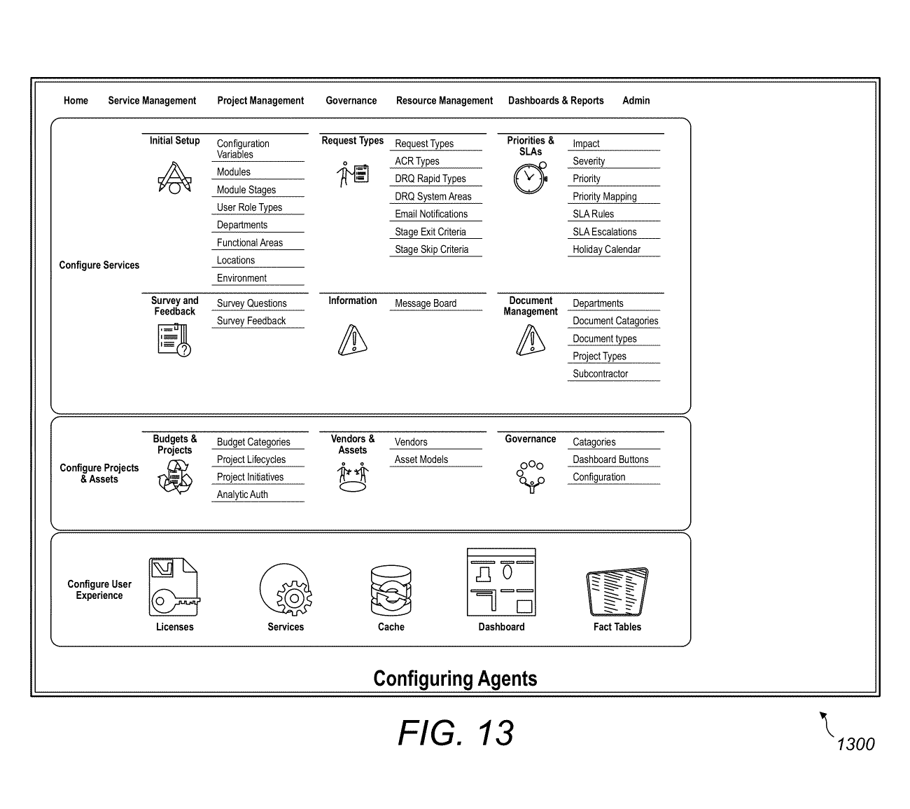

FIG. 13 shows several configuring agents 1300. Some representative configuring agents such as configure service, configure project and assets, and configure user experience are shown. This may span across various departments. Various break down elements for creating this agent dashboard is shown for each agent services. For example. For “configure services” there is an initial set up, request type, priorities and SLA. Each of these categories is further broken down to give further clarity and reach for creating modular intelligent agents.

FIG. 14 is a graphical user interface for project flow 1400. This is the simplest dash board which shows how easy and usable this integrated system is. Simplicity combined with underlying novel relative variance based real time integrated tool is unique and eliminates the need to use disparate sources for project management. The start of the project idea to the finish and to the approval, the project is streamlined as one smooth integrated approach. It makes complex specific projects more manageable with real time cost analysis and a grip on budget realistic.

The instant system, method and process enables the project formation, execution, and monitoring of the specific project intelligently and securely updated and maintained throughout the life time of the specific project. The constraints and rules may be implemented in compliance to any user/users organization. The system, method and process eliminate information about budget over runs, and ensuring that internal and external user/customer gets the information they need to achieve their objectives. Even though the software is platform agnostic the display is also platform agnostic. The additional security enables the users of different professions to be comfortable to use it on any device including mobile devices.

Although the present embodiments have been described with reference to specific example embodiments, it will be evident that various modifications and changes may be made to these embodiments without departing from the broader spirit and scope of the various embodiments.

What is claimed is:

1. A system, comprising:
a processor, in a machine-readable media, housing a variety of modules to perform an integrated management for an enterprise;
a service management module having a service design module, service implementation module, service improvement module, management module for service, service cost module, service personnel module, service schedule module, service assessment module and service review module to perform effective service management;
a project management module having a having a project scope module, project cost module, personnel module, project schedule module, project assessment module, project review module, relative variance module, scope creep module, project cost module, resource management module, critical issue assessment module, project schedule module, budget management module, and application/workflow module to deliver a project on time and budget; and
a governance module having an efficiency centric module, business risk module, revenue management module, regulatory module, project monitoring module, review project module and approval module for all involved personnel to approve, review and complete the project.

2. The system of claim 1, wherein the relative variance module uses a formula 2 and formula 3 for calculating an organizational dynamics to manage a project efficiently across the organization.

3. The system of claim 1, wherein the service management module, project management module and the governance module are used as a modular analytical tool.

4. A system, comprising:
a modular analytical tool to gather a varied data from a group involved in a specific project;
an enterprise management system to calculate, evaluate, change and present weighted project variance value for the specific project for review, update and approval of a decision maker, service provider and user to effectively manage the specific project; and
a network enabled centralized enterprise module for conducting efficient project management for the specific project.

5. The system of claim 4, further comprising:
a modular intelligent agent to help customization of an attribute required by the decision maker, service provider and user for uploading new features, reports, and input for the special project to monitor, manage, triage, assess progress and take decisions.

6. The system of claim 4, wherein the modular analytical tool is supported by a processor, in a machine-readable media, in form of a module to support the enterprise management for an enterprise, wherein the module is a service management module having a project scope module, cost module, personnel module, schedule module, assessment module and review module to perform effective service management.

7. The system of claim 6, wherein the module is a project management module having a relative variance module, scope creep module, cost module, resource management module, critical issue assessment module, schedule module, budget module, and application/workflow module to deliver a project on time and budget; and

[symbol]

8. The system of claim 6, wherein the module is a governance module having an efficiency centric module, business risk module, revenue management module, regulatory module, project monitoring module, review project module and approval module for all involved personnel to approve, review and complete the project.

9. The system of claim 8, wherein the governance module is customizable by the decision maker, service provider and user.

10. A method, comprising:
collecting a data from a service management module, resource management module, project management module and calculating a relative variance value for a granular attribute that integrates into a specific project;
calculating and presenting the relative variance value as a weighted project variance across for the granular attribute that influences the specific project goals for an integrated enterprise system, to a decision maker, service provider and user; and
enabling assessment of the specific project at a specific point to a member of the specific project and make necessary allocation of a service, resource and project related allocation.

11. The method of claim 10, further comprising:
designing the specific project by the decision maker, service provider and user by using the modular intelligent agent; and
monitoring the specific project by the decision maker, service provider and user by using the modular intelligent agent.

12. The method of claim 11, further comprising:
adjusting the allocation of the service, resource and the project related allocation in response to a critical issue assessment result.

13. The method of claim 12, further comprising:
alerting a change in at least one of a critical issue, business risk issue, schedule, budget, scope creep and resource to the decision maker, service provider and user by using the modular intelligent agent.

14. The method of claim 10, further comprising:
permitting customization of a graphical user interface for the decision maker, service provider and user by using the modular intelligent agent to observe a workflow of the specific project.

15. The method of claim 14, further comprising:
displaying a project flow chart for a decision maker, service provider and user with appropriate indication of a decision requirement to move forward for the specific project by the modular intelligent agent.
